(19) United States
(12) Patent Application Publication
(10) Pub. No.: US 2016/0162632 A1
(43) Pub. Date: Jun. 9, 2016

(54) METHOD OF SCREENING REACTIONS OR BIOLOGICAL PATHWAYS INDUCED BY COMPOUND

(71) Applicant: Samsung Electronics Co., Ltd., Suwon-si (KR)

(72) Inventors: Sojeong Yun, Hwaseong-si (KR); Taeyong Kim, Daejeon (KR); Sangchul Park, Seongnam-si (KR)

(21) Appl. No.: 14/959,051

(22) Filed: Dec. 4, 2015

(30) Foreign Application Priority Data
Dec. 4, 2014 (KR) 10-2014-0173233

(51) Int. Cl. G06F 19/12; C40B 30/02

(52) U.S. Cl. CPC G06F 19/12; C40B 30/02

(57) ABSTRACT

Provided is a method of screening biochemical reactions induced by a compound or biological pathways induced by a compound.

### RELATED APPLICATION

This application claims the benefits of Korean Patent Applications No. 10-2014-0173233 filed on Dec. 4, 2014 in the Korean Intellectual Property Office, the entire disclosure of which is hereby incorporated by reference.

### BACKGROUND

1. Field

The present disclosure relates to methods of screening reactions or pathways induced by a compound.

2. Description of the Related Art

In the field of pharmaceutics, a methodology for predicting decomposition products of a drug has been developed. However, the methodology is simply for predicting compounds produced by organic chemical reaction mechanisms. In order to study the effects of compounds on cells, prediction of reactions or biological pathways in the cells that may be affected by the compounds is important.

### SUMMARY

Provided are methods of screening for biochemical reactions induced by a compound in a cell or organism.

Additional aspects will be set forth in part in the description which follows and, in part, will be apparent from the description, or may be learned by practice of the presented exemplary embodiments.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a flowchart of a method of screening biological reactions in cells induced by a compound.

FIG. 2A is a flowchart of a method of selecting biological reactions for a compound.

FIG. 2B is a block level diagram of a device for selecting biochemical reactions for a compound.

FIG. 3A is a flowchart illustrating the determining a functional region and a linker region of a compound, according to an aspect of an embodiment.

FIG. 3B illustrates an example of identifying a transformation region and determining a functional region and a linker region based on the identification.

FIG. 4 illustrates transformation grouping and transformation library creation, according to an aspect of an embodiment.

FIG. 5A illustrates reactions predicted as being involved in conversion from ornithine to putrescine.

FIG. 5B illustrates reactions predicted as being involved in conversion from 1-aminooxy-3-aminopropane to NCC(CON)C(O)═O.

FIG. 5C illustrates reactions predicted as being involved in conversion from 1-aminooxy-3-aminopropane to O-aminoaminohomoserine (Formula: NOCCC(N)C(O)═O).

FIG. 6A illustrates reactions predicted as being involved in conversion from dapsone to CC(═O)Nc1ccc(cc1)S(═O)(═O)c1ccc(N)cc1.

FIG. 6B illustrates reactions predicted as being involved in conversion from dapsone to Nc1 ccc(cc1)S(═O)(═O)c1ccc(NP(O)(O)═O)cc1.

FIG. 7 illustrates pathways predicted as including a gene with a change in expression level thereof by dapsone.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Provided herein is a method of screening or predicting biochemical reactions induced or affected in a cell by a specific compound when used to treat the cell. The term “specific compound” is used herein to refer to a compound of interest (e.g., a target compound or test compound), such as a potential therapeutic compound. According to an embodiment, the method includes selecting two or more biochemical reactions for a specific compound from biochemical reactions known or determined to be associated with the specific compound by comparing one or more functional regions of the compound with one or more functional regions in a transformation library; identifying a set of genes, proteins, and/or metabolites differentially expressed in a cell, in response to a contact between the specific compound and the cell; selecting one or more biological pathways associated with the set of differentially expressed genes, proteins, and/or metabolites from known biological pathways; and determining the biochemical reaction included in the selected biological pathway, among the selected biochemical reactions, as a biochemical reaction induced in the cell by treatment with the test compound. Each of the steps may be performed by at least one computer processor. The at least one processor may be operably connected to a memory device.

The term “biochemical reaction” used herein refers to conversion of one molecule to another molecule, which is mediated by an enzyme in a cell. In the biochemical reaction, an enzyme binds to a substrate and catalyzes conversion of the substrate to a product (e.g., metabolite). The biochemical reaction may be classified or identified according to KEGG reaction ID, EC number, reaction definition, types of a reactant and a product, or a combination thereof. The term “biological pathway” used herein refers to a series of reactions (e.g., chemical or biochemical reactions) between molecules in a cell that leads to a certain product or a change in a cell. The biological pathway may be a metabolic pathway, a gene regulation pathway, or a signal transduction pathway.

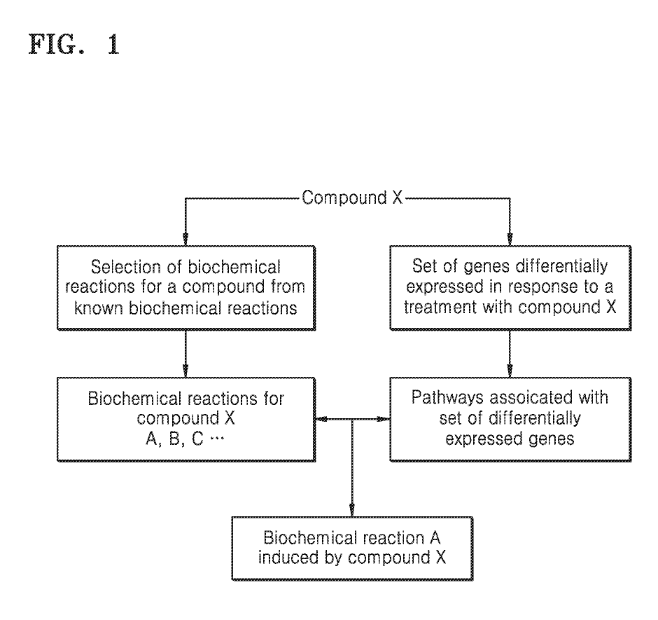

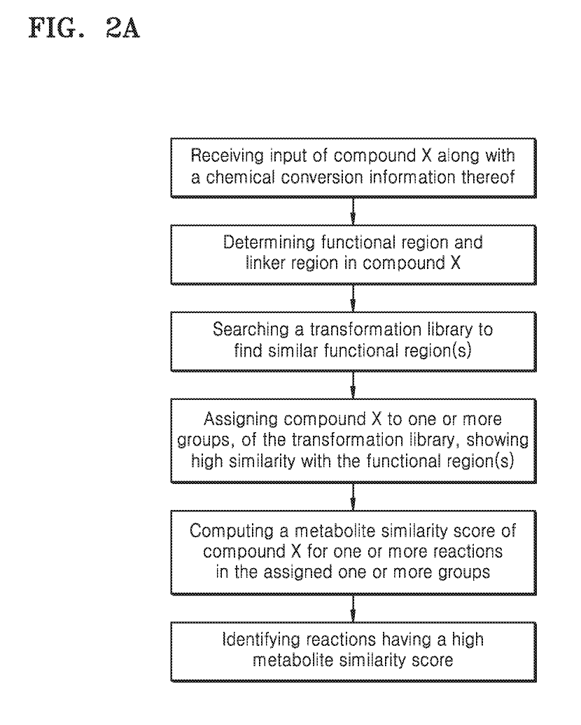

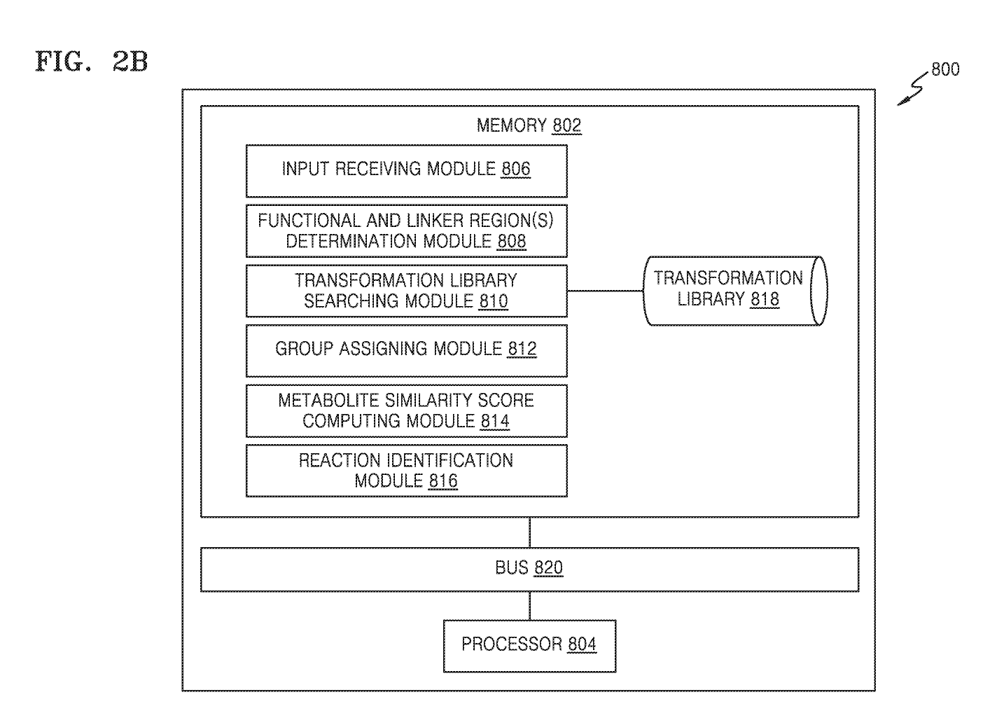

FIG. 1 is a flowchart of a method of screening biological reactions in a cell induced by compound X. Two or more biochemical reactions for compound X are selected from known biochemical reactions, using a method for selecting biochemical reactions for a compound as shown in FIG. 2A. The method as shown in FIG. 2A may be performed by the device as shown in FIG. 2B. The device 800 may include processor(s) 804, and memory 802 coupled to the processor(s) 804. The memory 802 includes a plurality of modules stored in the form of executable program code which instructs the processor(s) 804 to perform the steps illustrated in FIG. 2A. The memory 802 may include an input receiving module 806, functional and linker region(s) determination module 808, transformation library searching module 810, group assigning module 812, metabolite similarity score computing module 814, and reaction identification module 816. The memory 802 may also store transformation library 818.

The input receiving module 806 may instruct the processor(s) 804 to receive input of the identity of compound X along with data describing a chemical conversion of compound X. The functional and linker region(s) determination module 808 may instruct the processor(s) 804 to determine one or more functional regions and one or more linker regions in compound X. The transformation library searching module 810 may instruct the processor(s) 804 to search a transformation library to find functional region(s) similar or identical to the one or more functional regions of compound X by scanning the transformation library 818 stored in the memory 802. The group assigning module 812 may instruct the processor(s) 804 to assign compound X to one or more groups of the transformation library showing high similarity with the one or more functional regions. The metabolite similarity score computing module 814 may instruct the processor(s) 804 to compute a metabolite similarity score of compound X for one or more reactions in the one or more assigned groups of the transformation library. The reaction identification module 816 may instruct the processor(s) 804 to identifying reactions having a high metabolite similarity score.

The method provided herein involves selecting two or more biochemical reactions for a specific compound from among known biochemical reactions. The known biochemical reactions may include reactions known or determined to be associated with the specific compound. The selecting two or more biochemical reactions for a specific compound may be achieved via comparing one or more functional regions of the compound with one or more functional regions in a transformation library. The step of the selecting two or more biochemical reactions for a specific compound from among known biochemical reactions may include, for example, receiving input of the identity of the compound (e.g., data describing the molecular structure or molecular formula of the compound) along with data describing a chemical conversion of the compound; determining one or more functional regions and one or more linker regions in the compound; searching (scanning) a transformation library to find functional region(s) similar or identical to the one or more functional regions in the transformation library; assigning the compound to one or more groups of the transformation library showing high similarity with the one or more functional regions; computing a metabolite similarity score of the compound for one or more reactions in the one or more assigned groups of the transformation library; and identifying reactions having a high metabolite similarity score. The similarity between functional regions of the compound and those of the transformation library may be determined by using a similarity measure for comparing chemical structures. The similarity measure may be the Tanimoto (or Jaccard) coefficient.

The data describing a chemical conversion (chemical conversion information) for the compound may include at least one of transformation region information and reaction conversion information. Transformation region information may be information (data) describing the structure of the transformation regions of the compound. The transformation region may be atoms or the chemical group or structure undergoing a change in bond connectivity or bond order. Reaction conversion information may be, for example, attributes governing the transformation. The data describing a chemical conversion for the compound may be represented by using simplified molecular-input line-entry system (SMILES) formulas for the compound and the product to which the compound is converted via the chemical conversion.

Determining one or more functional regions and one or more linker regions in the compound may include identifying one or more transformation regions for the compound based on the data describing a chemical conversion of the compound; extracting information (data) describing the structure of the one or more transformation regions of the compound; and identifying one or more functional regions and one or more linker regions in the compound from the extracted information describing one or more transformation regions. The transformation region for the reactant molecule may be identified by comparing it to corresponding product molecule.

The functional region(s) of the compound can be determined based on the chemical conversion information. A functional region of a compound is the region that participates in or is necessary for a given reaction to take place. A functional region may include at least one transformation region (e.g., a chemical group or structure that changes as a result of the chemical conversion reaction) alone or together with at least one other region of interest (e.g., region that participates in some way, perhaps indirectly, in a chemical reaction). The linker region(s) may include the residual part of the compound outside of the identified functional group(s) in the compound. Thus, the functional regions can be determined, for instance, by comparing the compound of interest before a chemical conversion reaction to the resulting compound after the chemical conversion reaction to determine which regions of the molecule change and by applying other general knowledge in the art to determine which other parts of the compound are involved in the reaction.

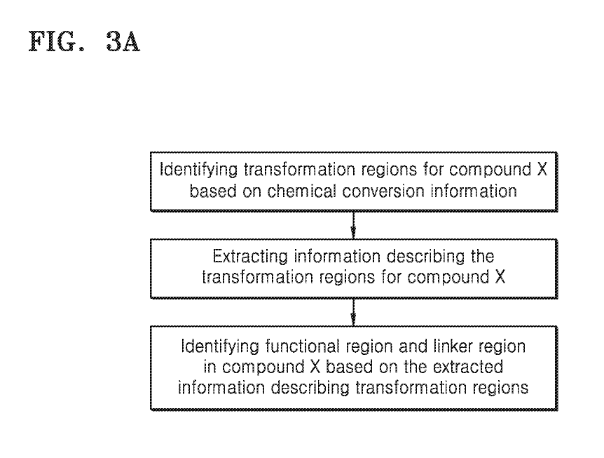

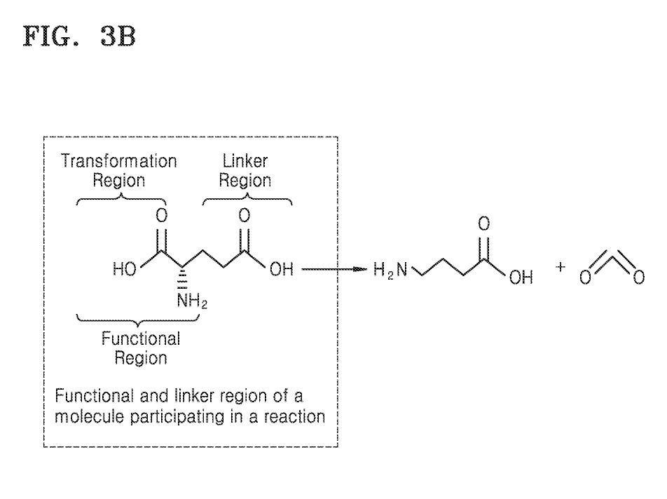

FIG. 3A is a flowchart illustrating a method of determining a functional region and a linker region of a compound, according to an aspect of an embodiment. FIG. 3B illustrates an example of identifying a transformation region and determining a functional region and a linker region based on the identification. In the given illustrative reaction, glutamate is converted to gamma amino butyric acid and carbon dioxide. During the reaction, a carboxyl group of amino butyric acid is cleaved. The carboxyl group is a region participating in the reaction and undergoing change, and thus considered a transformation region. Also, a C—NH₂ group adjacent to —COOH is necessary for transformation even though not undergoing transformation during the reaction, and thus forms a region of interest. The transformation region along with the region of interest is considered to be a functional region, while the residual region of the compound forms the linker region. Thus, a processor can receive information that describes the structure of glutamate and chemical conversion information describing the conversion of glutamate to gamma amino butyric acid and carbon dioxide. By analyzing and comparing information describing the products (e.g., structure or formula of the products) to the information describing the reactant (glutamate), the processor can determine that the carboxyl group participates in the reaction and undergoes a change. This structure is designated by the processor as a transformation region. Using other known reaction rules that generally apply to such reactions, as known in the art, the processor can determine that the C—NH₂ group adjacent to —COOH is necessary for transformation even though not undergoing transformation during the reaction, and thus is designated by the processor as a region of interest. The processor then groups the transformation region and region of interest to create the functional region, and designates the remaining parts of the structure as the linker region.

The structure or formula of functional region of the test compound is used by the processor to search or scan a transformation library. The transformation library is a library or database of information or data describing reactions categorized into a plurality of groups of one or more reactions undergoing similar chemical conversions represented by one or more functional regions and associated information (e.g., a list of at least one enzyme catalyzing the reaction(s) and the extracted functional region(s) and linker region(s) of the reaction(s)). The transformation library is generated by grouping similar reactions based on the functional region similarity. The transformation library may include a collection of previously reported bio-molecular conversions. The transformation library may include a plurality of groups of chemical reactions. Each of the groups may include chemical reactions undergoing similar chemical conversion, a list of enzyme(s) catalyzing each of the reactions, and the functional and linker region(s) of each of the reactions. Each of the groups has representative functional region(s). In the present specification, the transformation library may also be referred to as “a reaction rule set.”

In the transformation library, the systematic arrangement of groups may make them useful in terms of group assignment and deriving metabolite similarity score. The similar chemical transformation may be identified by matching up the at least one functional region among the reactions.

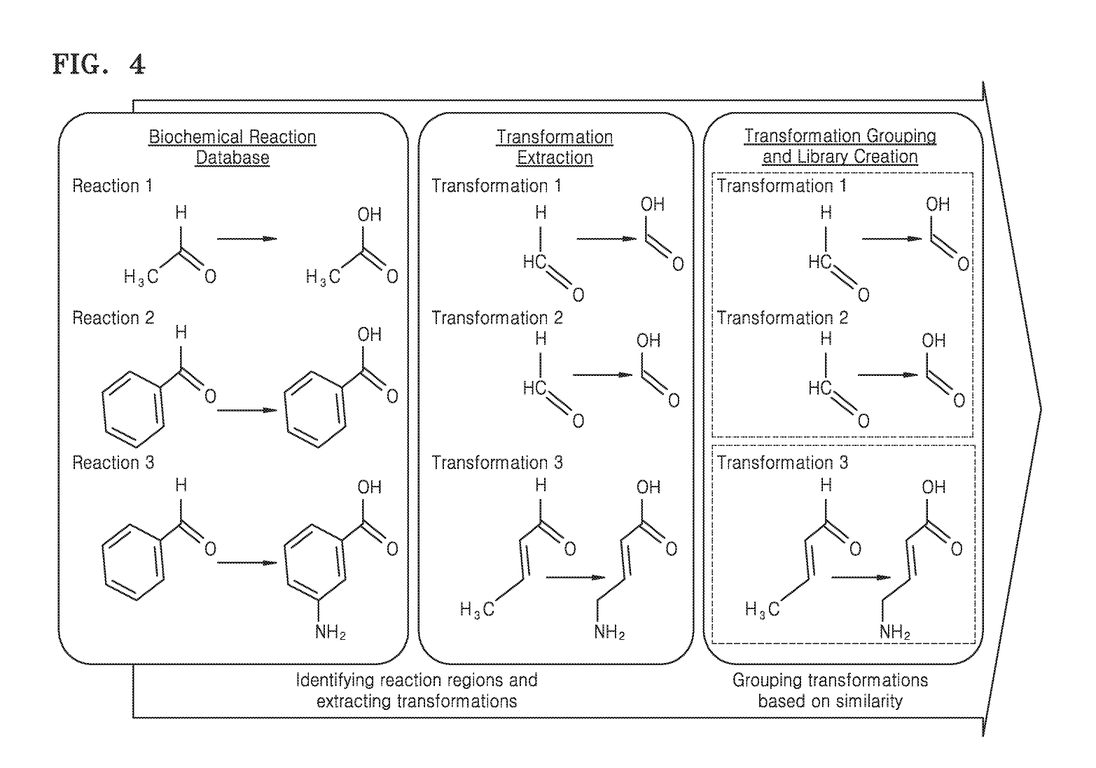

FIG. 4 illustrates transformation grouping and transformation library creation, according to an embodiment. After obtaining various reactions from various biochemical databases as input, each of the reactions is split into reactant and product, and the molecule(s) that undergoes transformation in each of the reaction may be identified. In other words, a processor determines which molecules of the reaction are reactants and products (or is supplied with this information), and the processor compares the structures of the reactant and product to determine which regions of the molecules are transformed. In this way, the transformation region(s) for each of the molecule participating in the reaction may be identified and information describing the structure of the transformation regions extracted. Other regions of interest in the molecules that are necessary for the reactions, but not transformed, also are identified by the processor through the application of supplied reaction rules. Based on the identified transformation region(s) and other regions of interest, the corresponding functional region(s) of the molecules may be identified and information describing the functional region(s) extracted. Once, the functional region(s) is/are identified, the linker region(s) related to the functional region(s) may be identified and extracted. Subsequently, the functional region(s) of each of the input reactions is/are compared with the functional region(s) of other input reactions to determine which reaction are similar to one another. Similar reactions are grouped together along with their functional and linker regions to constitute the transformation library. Generating the transformation library may be performed by a computing device.

After identifying reactions in the transformation library involving the same or similar structures as the functional regions of the compound of interest, a metabolite similiarity score can be computed. As mentioned above, the reactions from the transformation library are grouped together with the functional regions involved in the reactions. The metabolite similarity score of the compound of interest with respect to one or more reactions in the assigned one or more groups may be computed by comparing the extracted information describing one or more functional regions of the compound of interest with the information describing one or more functional regions of the assigned one or more groups of the transformation library; comparing the extracted information describing one or more linker regions of the compound of interest with the information describing one more linker regions of the one or more reactions of the assigned one or more groups of the transformation library; and computing a similarity score based on the comparison of the one or more functional regions and the one or more linker regions of the compound of interest with those of the transformation library.

The similarity between the regions of the compound of interest and the regions identified in the transformation library is termed metabolite similarity, and a score representing the similarity obtained by the comparison is called as metabolite similarity score. The reactions of the assigned group(s) of the transformation library which produce a high metabolic similarity score is/are selected as likely candidate biochemical reactions for a test compound in the screening method.

Computing a metabolite similarity score is illustrated in greater detail as follows. The compound may be represented as a function of two components, the functional region(s) and the linker region(s). In Equation 1 as below, A is an input compound, a is a functional region(s) of the compound A, and β is a linker region(s) of the compound A.

A=f(α,β) <Equation 1>

The metabolite similarity (MS) score between an input compound A and a representative reaction within a group in transformation library is defined by Equation 2 as below:

$$MS = \frac{{a}_{1} T ( {A}_{α} , α ) + {a}_{2} T ( {A}_{β} , β )}{{a}_{1} + {a}_{2}} \qquad 〈 Equation 2 〉$$

where, A_{α} is a functional region(s) of compound A, A_{β} is a linker region(s) of compound A, α is a representative functional region(s) of a group in the transformation library, β is a linker region(s) of a reaction in the group, T(A_{α}, α) is chemical similarity (Tanimoto coefficient) of functional region(s) of compound A and representative functional region(s) of the group, T(A_{β}, β) is chemical similarity (Tanimoto coefficient) of linker region(s) of compound A and linker region(s) of a reaction in the group, and a₁ and a₂ are each respectively weighting factors for functional and linker regions. Further, similarity could have been assessed through other equivalent metrics such as, but not limited to, root mean square deviation, equivalence overlap, etc., for structural similarity; dice, cosine, etc., for chemical similarity; feature based; etc.

The method involves identifying a set of genes, proteins, and/or metabolites differentially expressed in a cell in response to treating or contacting the cell with the specific compound of interest. The set of differentially expressed genes, proteins, or metabolites may be obtained from a database of one or more gene expression profiles and/or metabolite profiles; experimental data providing one or more gene expression profiles and/or metabolite profiles; or a combination thereof. The database including at least one gene expression profile and/or metabolite profile may be a public database, for example, Gene Express Omnibus (GEO) by NCBI, ArrayExpress, Stanford microarray database, KEGG, PubChem, MetaCyc, ChEBI, PDB, UniProt, GenBank, or Human Metabolome Database (HMDB). The gene expression profile and metabolite profile may be analyzed in cells in contact with or after contacting with the specific compound. The set of differentially expressed genes, proteins, or metabolites may be those selected using known methods. For example, the gene or metabolite expression profile can be statistically processed to determine which genes or metabolites are differentially expressed to a statistically significant degree, and according to the results of statistical analysis, the set of differentially expressed genes, proteins, or metabolites can be selected.

Biological pathways associated with the set of differentially expressed genes, proteins, and/or metabolites may be selected based on a value representing a relationship between the set and each of the pathways, wherein the value is computed from a database having information about known biological pathways. The database having information about known biological pathways may be a public database, for example, KEGG, BioCarta pathway, MetaCyc, Database for Annotation, Visualization and Integrated Discovery (DAVID), AmiGO, or PANTHER. The value representing a relationship between the set and each of the pathways may be, for example, a p-value. The p-value statistically represents a degree of the association of the set with the corresponding pathway, and the smaller p-value indicates that the genes, proteins, or metabolites to be input are statistically significantly enriched in the corresponding pathways.

According to an aspect of another exemplary embodiment, a method of screening or predicting biological pathways induced or affected by a specific compound when used to treat cells includes identifying a product transformed from a specific compound (e.g., a metabolite of the specific compound) through the biochemical reaction determined by the method of screening biochemical reactions induced in a cell by treatment with a specific compound; screening biochemical reactions for the identified product according to the method of screening biochemical reactions (e.g., using the product as the compound of interest in the previously-described screening method) to determine the biochemical reaction induced in the cell by treatment with the identified product; selecting the biological pathway from among known biological pathways, wherein the selected pathway comprises the biochemical reaction determined by the method of screening biochemical reactions, followed by the biochemical reaction induced in the cell by treatment with the identified product; and determining the selected biological pathway as a biological pathway induced in the cell by treatment with the specific compound.

Selecting biological pathways including the screened reactions may be performed by using information stored in a database having information about biological pathways, where the database may be a public database, for example, KEGG, BioCarta pathway, MetaCyc, Database for Annotation, Visualization and Integrated Discovery (DAVID), AmiGO, or PANTHER.

In the method of screening biological pathways, the identifying and screening steps may be repeated at least twice.

The present invention will be described in further detail with reference to the following examples. These examples are for illustrative purposes only and are not intended to limit the scope of the present invention.

### EXAMPLE 1

### Prediction of Reactions in Cells

1.1. Prediction of Reactions in Cells Using a Natural Enzyme Substrate

Reactions in a cell induced by ornithine, which is known to be a natural subatrate of ornithine decarboxylase (ODC), were predicted. The structure of ornithine was transformed to a formula of NCCC[C@H](N)C(O)═O via the simplified molecular-input line-entry system (SMILES). By using a method of selecting biochemical reactions for a compound among known biochemical reactions, 32 candidate products that are predicted to be produced from ornithine were obtained as shown in Table 1. Specifically, a reaction rule set was prepared by classifying all enzyme reactions occurring in a cell according to the Enzyme Commission number (EC number) thereof and grouping the classified enzyme reactions based on the functional region similarity. Thus, a certain reaction rule in the reaction rule set includes a plurality of groups of EC numbers each of which has a plurality of enzyme reactions. Meanwhile, transformation regions and regions of interest for ornithine were determined from data describing chemical conversions of ornithine. Based on the transformation regions and regions of interest for ornithine, the applicable reaction rules among reaction rules in the reaction rule set were chosen. By applying the chosen reaction rules to ornithine, candidate products of ornithine were obtained.

TABLE 1

| | |
|---|---|
| Candidate | NCCCCN, NCCC═C(N)C(O)═O, NC1CCCNC1═O, NCCCC(N)C═O, |
| products | NCCCC(N)C(═O)S[Cs], NC═CCC(N)C(O)═O, CC(N)CC(N)C(O)═O, |
| | NC(CCC═N)C(O)═O, NC(CCC═O)C(O)═O, NCCC(O)C(N)C(O)═O, |
| | NCC(O)CC(N)C(O)═O, NCCC(N)CC(O)═O, NCC═CC(N)C(O)═O, |
| | NCCCC(═N)C(O)═O, NCCCC(N)C(N)═O, NC(O)CCC(N)C(O)═O, |
| | NCCCC(N)(O)C(O)═O, NCCCC(═O)C(O)═O, NCCCC(N)C(═O)OP(O)(O)═O, |
| | COC(═O)C(N)CCCN, NC(CO)CCC(N)C(O)═O, NCC(CC(N)C(O)═O)C(O)═O, |
| | NCCCC(NC(N)═N)C(O)═O, NC(CCC(N)C(O)═O)C(O)═O, |
| | NCCCC(N)(C(O)═O)C(O)═O, NCCC(C(N)C(O)═O)C(O)═O, NCCCC(N)(CO)C(O)═O, |
| | NC(CCCNC(N)═N)C(O)═O, CNC(═O)C(N)CCCN, CC(OC(═O)C(N)CCCN)C(O)═O, |
| | NCCCC(N)C(O)═CC(═O)C(O)═O, CC(O)C(═O)OC(═O)C(N)CCCN |

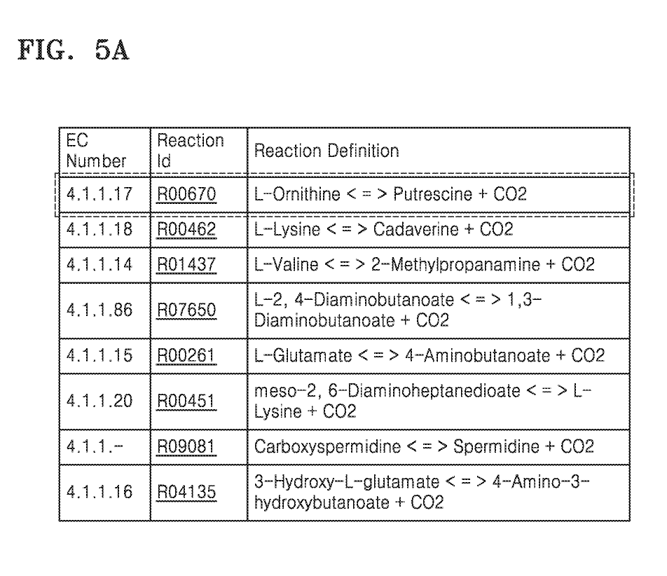

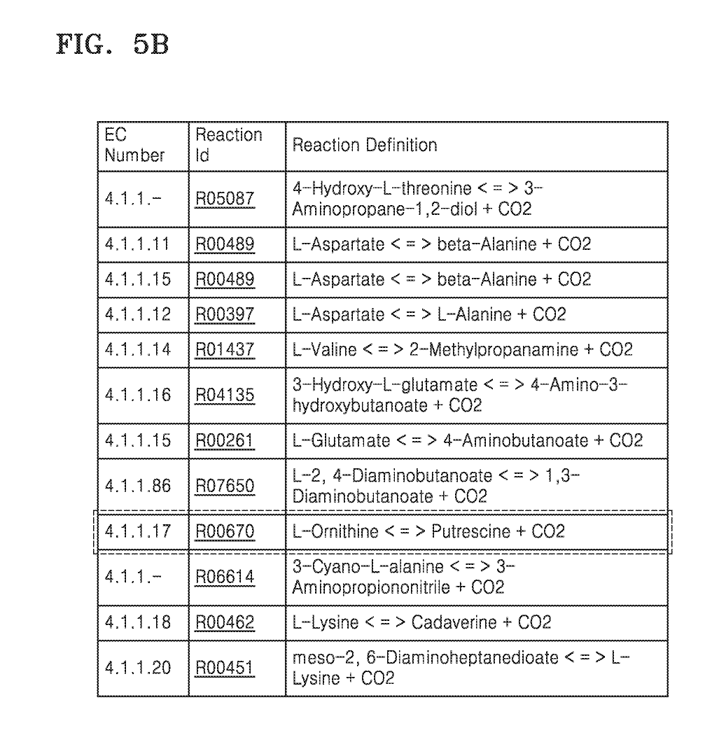

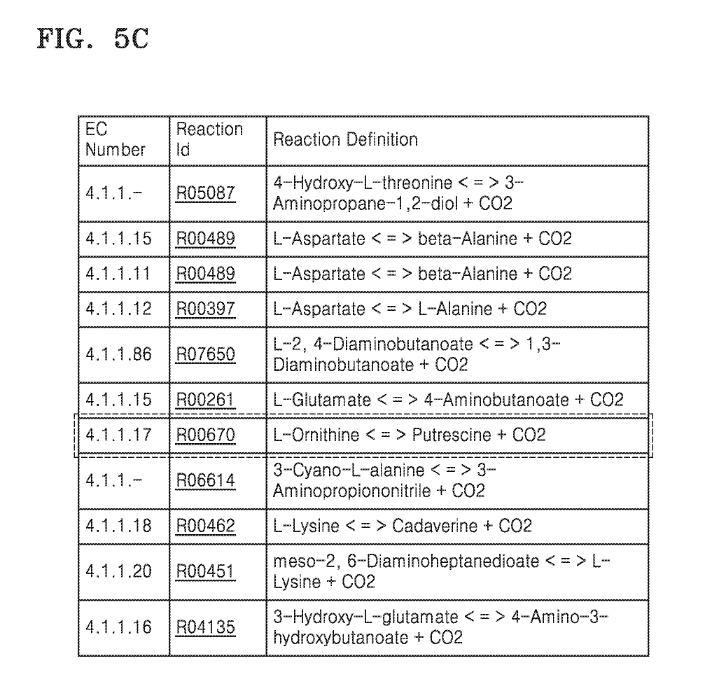

FIG. 5A illustrates reactions predicted as being involved in conversion from ornithine to putrescine (NCCCCN in SMILES). The reaction rule applied in the conversion of ornithine to putrescine has a plurality of enzyme reactions, as shown in a form of a list of EC number, reaction ID, and reaction definition in FIG. 5A. Enzymes corresponding to these enzyme reactions are those predicted as having a possibility to catalyze the conversion of ornithine to putrescine. These enzyme reactions included the known L-ornithinecarboxy-lyase (putrescine-formation) reaction (KEGG reaction ID: R00670). In this regard, it was confirmed that the method of the embodiment may be used in prediction of reactions in a cell of a natural substrate.

1.2. Prediction of Rreactions in Cells for a Synthetic Substrate

Reactions in a cell induced by 1-aminooxy-3-aminopropane, which is a synthetic substrate of ODC, were predicted. A structure of 1-aminooxy-3-aminopropane was transformed to a formula of NCCCON via SMILES. By using a method of selecting biochemical reactions for a compound, as described in Example 1.1, 13 candidate products predicted to be produced from 1-aminooxy-3-aminopropane were obtained as shown in Table 2.

TABLE 2

| | |
|---|---|
| Candidate | CC(N)CON, NCCC(O)ON, NOCC═CN, NOCCC═N, NCC(O)CON, NOCCC(N)O, |
| products | NCC═CON, NOCCC═O, NCC(CON)C(O)═O, NOCCC(N)C(O)═O, |
| | NOCCC(N)CO, NOCCCNC(N)═N, NCCCONC(N)═N |

FIG. 5B illustrates reactions predicted as being involved in conversion from 1-aminooxy-3-aminopropane to NCC(CON)C(O)═O. FIG. 5C illustrates reactions predicted as being involved in conversion from 1-aminooxy-3-aminopropane to O-aminoaminohomoserine (Formula: NOCCC(N)C(O)═O ). The reaction rules respectively applied in the conversion of 1-aminooxy-3-aminopropane to NCC(CON)C(O)═O and the conversion of 1-aminooxy-3-aminopropane to NOCCC(N)C(O)═O have a plurality of enzyme reactions, as shown in a form of a list of EC number, reaction ID, and reaction definition in FIG. 5B and 5C. Enzymes corresponding to these enzyme reactions are those predicted as having a possibility to catalyze the conversion of 1-aminooxy-3-aminopropane to NCC(CON)C(O)═O or the conversion of 1-aminooxy-3-aminopropane to NOCCC(N)C(O)═O. The predicted reactions included the known L-ornithinecarboxy-lyase (putrescine-formation) reaction (KEGG reaction ID: R00670). In this regard, it was confirmed that the method of the embodiment may be used in prediction of reactions in a cell of a synthetic substrate.

EXAMPLE 2

### Prediction of Reactions in Cells of Dapsone

2.1. Prediction of Reactions Using a Method of Determining Biochemical Reactions for a Compound

Dapsone is a known substrate of N-acetyl-transferase (NAT2) or pyruvate kinase (GELBER, R. et al., The polymorphic acetylation of dapsone in man., Clin. Pharmacol. Ther. 12(2):225-238, 1971; Cho SC et al., DDS, 4,4′-diaminodiphenylsulfone, extends organismic lifespan., PNAS, 2010 Nov. 9; 107(45):19326-31). A structure of dapsone was transformed to a formula of NC1=CC═C(C═C1)S(═O)(═O)C1=CC═C(N)C═C1 via SMILES. By using a method of selecting biochemical reactions for a compound, as described in Example 1.1, candidate products predicted to be produced from dapsone were obtained as shown in Table 3.

TABLE 3

| Candidate products having 12 or less | Candidate products having 12 or more |
|---|---|
| carbons | carbons |
| NC1═CCC(C═C1)S(═O)(═O)c1ccc(N)cc1 | NC(═N)Nc1ccc(cc1)S(═O)(═O)c1ccc(N)cc1 |
| NC1═CC(O)C(O)(C═C1)S(═O)(═O)c1ccc(N)cc1 | Nc1ccc(cc1)S(═O)(═O)c1ccc(NC(O)═O)cc1 |
| Nc1ccc(cc1)S(═O)(═O)C1═CC2OC2(N)C═C1 | Nc1ccc(cc1)S(═O)(═O)c1ccc(N)c(c1)C(O)═O |
| NC1═CC═C(C(O)C1O)S(═O)(═O)c1ccc(N)cc1 | CNc1ccc(cc1)S(═O)(═O)c1ccc(N)cc1 |
| Nc1ccc(cc1)S(═O)(═O)c1ccc(O)cc1 | CC(═O)Nc1ccc(cc1)S(═O)(═O)c1ccc(N)cc1 |
| Nc1ccc(cc1)S(═O)(═O)c1ccc(N)cc1O | CC(O)c1cc(N)ccc1S(═O)(═O)c1ccc(N)cc1 |
| NC1CC═C(C═C1)S(═O)(═O)c1ccc(N)cc1 | CC(O)c1cc(ccc1N)S(═O)(═O)c1ccc(N)cc1 |
| Nc1ccc(cc1)S(═O)(═O)c1ccc(N)c(c1)S(O)═O | NC(Cc1cc(ccc1N)S(═O)(═O)c1ccc(N)cc1)C(O)═O |
| NC1═CC2OC2(C═C1)S(═O)(═O)c1ccc(N)cc1 | NC(Cc1cc(N)ccc1S(═O)(═O)c1ccc(N)cc1)C(O)═O |
| Nc1ccc(cc1)S(═O)(═O)C1═CC(O)C(N)(O)C═C1 | |
| NC1═CC═C(C2OC12)S(═O)(═O)c1ccc(N)cc1 | |
| NC1═CC═C(CC1)S(═O)(═O)c1ccc(N)cc1 | |
| Nc1ccc(cc1)S(═O)(═O)c1ccc(N)c(O)c1 | |
| Nc1ccc(cc1)S(═O)(═O)c1ccc(NS(O)(═O)═O)cc1 | |
| Nc1ccc(cc1)S(═O)(═O)c1ccc(N)cc1S(O)═O | |
| Nc1ccc(cc1)S(═O)(═O)c1ccc(NP(O)(O)═O)cc1 | |

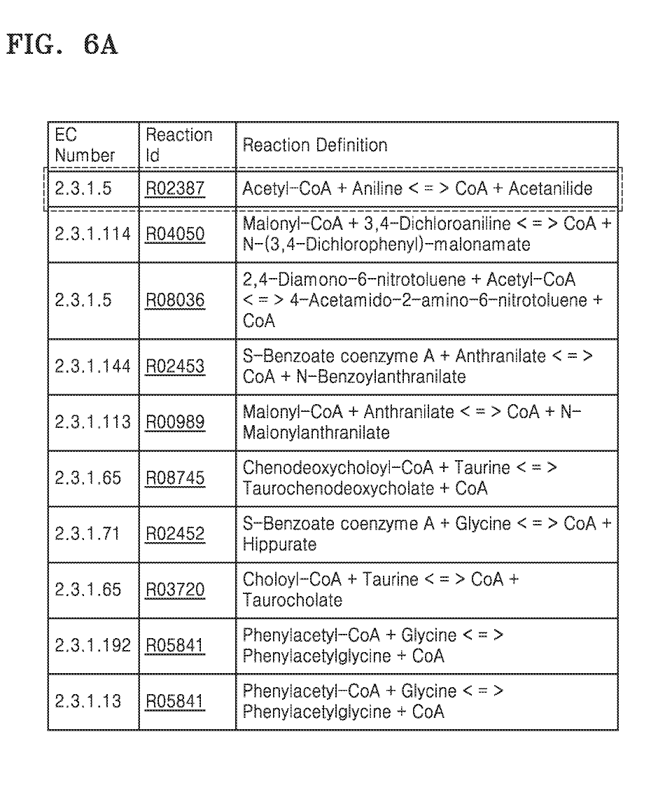

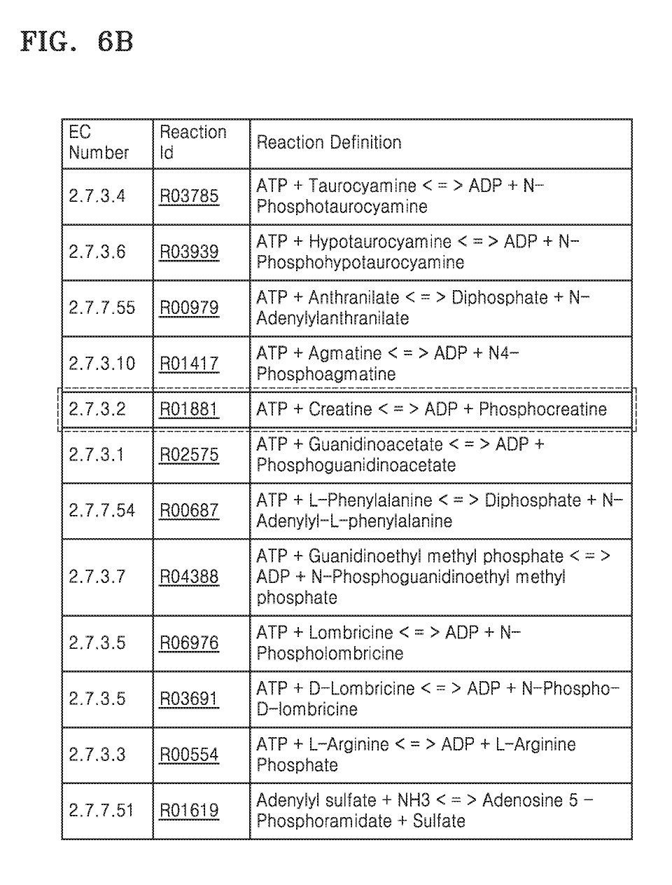

FIG. 6A illustrates reactions predicted as being involved in conversion from dapsone to CC(═O)Nc1ccc(cc1)S(═O)(═O)c1ccc(N)cc1. The reaction rule applied in the conversion of dapsone to CC(═O)Nc1ccc(cc1)S(═O)(═O)c1ccc(N)cc1 has a plurality of enzyme reactions, as shown in a form of a list of EC number, reaction ID, and reaction definition in FIG. 6A. Enzymes corresponding to these enzyme reactions are those predicted as having a possibility to catalyze the conversion of dapsone to CC(═O)Nc1ccc(cc1)S(═O)(═O)c1ccc(N)cc1. The predicted reactions included an acetyl-CoA:arylamine N-acetyltransferase reaction (KEGG reaction ID: R02387), which was consistent with the reactions described in the above referenced articles.

FIG. 6B illustrates reactions predicted as being involved in conversion from dapsone to Nc1ccc(cc1)S(═O)(═O)c1ccc(NP(O)(O)═O)cc1. The reaction rule applied in the conversion of dapsone to Nc1ccc(cc1)S(═O)(═O)c1ccc(NP(O)(O)═O)cc1 has a plurality of enzyme reactions, as shown in a form of a list of EC number, reaction ID, and reaction definition in FIG. 6B. Enzymes corresponding to these enzyme reactions are those predicted as having a possibility to catalyze the conversion of dapsone to Nc1ccc(cc1)S(═O)(═O)c1ccc(NP(O)(O)═O)cc1. The predicted reactions includes an ATP:creatine N-phosphotransferase reaction (KEGG reaction ID: R01881), which was consistent with that dapsone is actually a substrate of a pyruvate kinase which belongs to kinases.

2.2. Selection By Using Experimental Data From Among Predicted Reactions

Genes that are differentially expressed (differentially expressed genes, DEGs) by dapsone were experimentally determined. Information about biochemical pathways to which the DEGs are involved was obtained by a functional annotation tool of bioinformatics resources (DAVID Bioinformatics Resources version 6.7 operated by the National Institute of Allergy and Infectious Diseases (NINDS), Bethesda, Md.; see Huang D W, Sherman B T, Lempicki R A. “Systematic and integrative analysis of large gene lists using DAVID Bioinformatics Resources,” Nature Protoc. 2009; 4(1):44-57; Huang D W, Sherman B T, Lempicki R A. “Bioinformatics enrichment tools: paths toward the comprehensive functional analysis of large gene lists,” Nucleic Acids Res. 2009; 37(1):1-13).

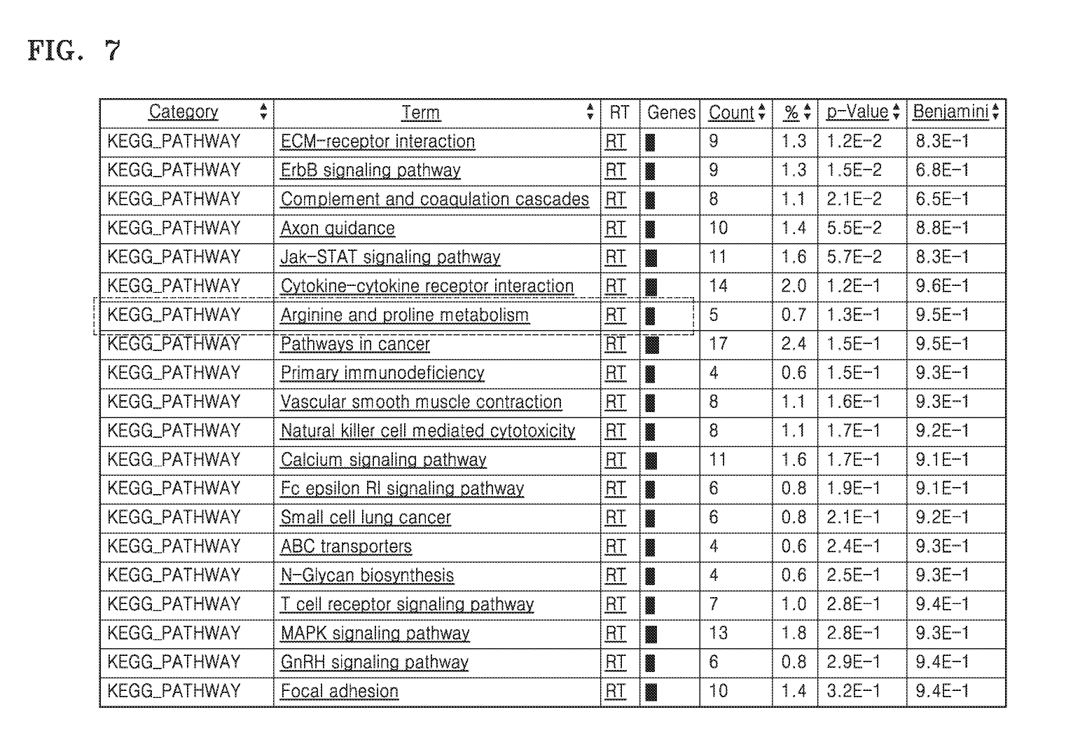

FIG. 7 illustrates information about biochemical pathways with which genes with a change in expression level thereof by dapsone are associated. The term “Term” refers to a pathway related to a gene list. The terms “Genes” and “Count” denotes the numbers of genes included in the corresponding terms. The length of the square in the column for “Genes” indicates the number of genes included in the corresponding terms. % refers to a ratio of genes included in the corresponding terms to genes input as DEGs of dapson. These pathways were identified in terms of whether each of the predicted reaction as described in Example 2.1. is included therein. A “arginine and prolyl metabolism” pathway among the obtained pathways included an ATP:creatine N-phosphotransferase reaction (KEGG reaction ID: R01881). Thus, the ATP:creatine N-phosphotransferase reaction, which is the enzyme reaction included in the obtained pathway, was determined as the enzyme reaction induced in a cell by treatment with dapson.

The results implies that among the reactions predicted in Example 2.1., the ATP creatine N-phosphotransferase reaction is more likely induced with dapsone treatment of a cell than the acetyl-CoA:arylamine N-acetyltransferase reaction.

It should be understood that the exemplary embodiments described herein should be considered in a descriptive sense only and not for purposes of limitation. Descriptions of features or aspects within each embodiment should typically be considered as available for other similar features or aspects in other embodiments.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of screening biochemical reactions induced in a cell by treatment with a test compound, the method comprising:
selecting two or more biochemical reactions for a test compound from known biochemical reactions by comparing one or more functional regions of the compound with one or more functional regions in a transformation library;
identifying a set of genes, proteins, or metabolites differentially expressed in a cell in response to contacting the cell with the test compound;
selecting one or more biological pathways known to be associated with the set of differentially expressed genes, proteins, or metabolites from known biological pathways; and
determining the biochemical reaction included in the selected biological pathway, among the selected biochemical reactions, as a biochemical reaction induced in the cell by treatment with the test compound,
wherein each of the steps are performed by at least one processor.

2. The method of claim 1, wherein selecting two or more biochemical reactions for a test compound among known biochemical reactions comprises:
receiving input of data describing the structure or formula of the test compound along with data describing a chemical conversion of the compound;
determining one or more functional regions and one or more linker regions in the compound;
searching a transformation library for functional region(s) with a structure similar to the structure of one or more functional regions of the test compound;
assigning the test compound to one or more groups of the transformation library with one or more functional regions showing high similarity with the one or more functional regions of the test compound;
computing a metabolite similarity score of the test compound for one or more reactions in the assigned one or more groups; and
identifying reactions having a high metabolite similarity score.

3. The method of claim 2, wherein determining one or more functional regions and one or more linker regions in the compound comprises:
identifying one or more transformation regions for the compound based on the data describing a chemical conversion of the compound;
extracting information describing the one or more transformation regions of the test compound;
identifying one or more functional regions and one or more linker regions in the compound based on the extracted information describing one or more transformation regions.

4. The method of claim 3, wherein the one or more functional regions comprise one or more transformation regions or one or more transformation regions along with one or more regions of interest.

5. The method of claim 2, wherein the one or more linker regions comprise the regions of the molecule other than the one or more functional regions.

6. The method of claim 2, wherein the transformation library is a database comprising a plurality of reaction groups, wherein each reaction group contains a data describing one or more reactions that involve similar chemical conversions, and each reaction group contains information describing one or more representative functional regions involved in the reactions.

7. The method of claim 6, wherein the reaction group further comprises a list of one or more enzymes catalyzing the one or more reactions, and information describing one or more linker regions of molecules involved in the one or more reactions.

8. The method of claim 2, wherein computing of a metabolite similarity score of the compound for one or more reactions in the assigned one or more groups comprises:
extracting information describing the structure of one or more functional regions and the one or more linker regions from information describing the structure of the test compound;
comparing the extracted information describing the structure of one or more functional regions of the test compound with information describing the structure of one or more functional regions of the assigned one or more groups of the transformation library;
comparing the extracted information describing the structure of one or more linker regions of the test compound with information describing the structure of one more linker regions of the one or more reactions of the assigned one or more groups of the transformation library; and
computing a similarity score based on the comparison of the one or more functional regions and the one or more linker regions.

9. The method of claim 1, wherein the biological pathways are metabolic pathways or signal transduction pathways.

10. The method of claim 1, wherein the set of differentially expressed genes, proteins, or metabolites is obtained from a database of gene expression profiles and/or metabolite profiles; from experimental data providing gene expression profiles and/or metabolite profiles; or from a combination thereof.

11. The method of claim 10, wherein the gene expression profile and metabolite profile are analyzed in cells in or after contact with the test compound.

12. The method of claim 1, wherein the biological pathways associated with the set of differentially expressed genes, proteins, or metabolites are selected based on a value representing a relationship between the set and each of the pathways, wherein the value is computed from a database having information about known biological pathways.

13. A method of screening biological pathways induced in a cell by treatment with a test compound, the method comprising:
identifying a product transformed from a test compound through the biochemical reaction determined by the method of claim 1;
screening biochemical reactions for the identified product according to the method of claim 1 to determine the biochemical reaction induced in the cell by treatment with the identified product;
selecting the biological pathway from among known biological pathways, wherein the selected pathway comprises the biochemical reaction determined by the method of claim 1, followed by the biochemical reaction induced in the cell by treatment with the identified product; and
determining the selected biological pathway as a biological pathway induced in the cell by treatment with the test compound.

14. The method of claim 13, wherein the identifying and screening steps are repeated at least twice.
